(19) United States
(12) Patent Application Publication
(10) Pub. No.: US 2026/0321964 A1
(43) Pub. Date: Oct. 15, 2026

(54) TERMINAL ANTENNA

(71) Applicant: HONOR DEVICE CO., LTD., Shenzhen (CN)

(72) Inventors: Dawei ZHOU, Shenzhen (CN); Yuanpeng LI, Shenzhen (CN)

(21) Appl. No.: 19/119,169

(22) PCT Filed: Sep. 1, 2023
(86) PCT No.: PCT/CN2023/116554

§ 371 Date: Apr. 8, 2025

(30) Foreign Application Priority Data
Oct. 14, 2022 (CN) 202211261353.8

(51) Int. Cl. H01Q 1/24; H01Q 9/16

(52) U.S. Cl. CPC H01Q 1/243; H01Q 9/16

(57) ABSTRACT

Embodiments of this application relate to the field of antenna technologies, and disclose a terminal antenna. Through a design of the present invention, high radiation performance is implemented when a radiator has a length less than ½ wavelength. In a specific solution, the antenna includes a first radiator, a length of the first radiator is less than a first value, and the first value corresponds to ½ wavelength of an operating frequency of the antenna. A first feed point and a second feed point are disposed at two ends of the first radiator respectively, the first feed point and the second feed point are connected to two signal output ends of a differential mode feed structure respectively, the two signal output ends have different polarities, and the two signals are equi-amplitude phase-inverted signals.

### CROSS-REFERENCE TO RELATED APPLICATIONS

This application is a national stage of International Application No. PCT/CN2023/116554, filed on Sep. 1, 2023, which claims priority to Chinese Patent Application No. 202211261353.8, filed on Oct. 14, 2022, both of which are incorporated herein by reference in their entireties.

### TECHNICAL FIELD

This application relates to the field of antenna technologies, and in particular, to a terminal antenna.

### BACKGROUND

An electronic device may provide a wireless communication function through an antenna disposed therein. With the development of electronic devices, quality requirements of wireless communication are increasingly high. In addition, an integration level of electronic devices is increasingly high. Consequently, a design space for an antenna is increasingly limited. Therefore, an antenna in an electronic device needs to provide better radiation performance and have a smaller size.

### SUMMARY

Embodiments of this application provide a terminal antenna. In this antenna solution, through an antenna design of the present invention, high radiation performance is implemented when a radiator has a length less than ½ wavelength.

To achieve the foregoing objective, the following technical solutions are used in embodiments of this application.

According to a first aspect, a terminal antenna is provided, and the antenna is used in an electronic device. The antenna includes a first radiator, a length of the first radiator is less than a first value, and the first value corresponds to ½ wavelength of an operating frequency of the antenna. A first feed point and a second feed point are disposed at two ends of the first radiator respectively, the first feed point and the second feed point are connected to two signal output ends of a differential mode feed structure respectively, the two signal output ends have different polarities, and the two signals are equi-amplitude phase-inverted signals.

In this way, based on the technical solution provided in this example, signals are fed through a differential mode feed disposed at two ends, so that excitation of the antenna can be implemented on a radiator with a length less than ½ wavelength. In some implementations, before feeding into the radiator by the differential mode feed, port matching may be further performed to enable a feed signal to match an antenna port, thereby implementing good radiation performance in an operating frequency band.

Optionally, a feed signal outputted by the differential mode feed structure and then inputted to the first radiator has a high-impedance port characteristic, and the high-impedance port characteristic is implemented by connecting a capacitor in series. In this way, the use of a differential mode feed structure outputting a low-impedance feed signal in the solution provided in this application can be implemented by connecting a capacitor in series. The capacitor may be configured to adjust an impedance characteristic of a signal, to enable a signal inputted to a radiator to have a high-impedance characteristic. Certainly, in some other embodiments, another manner may be used to enable a signal inputted to the radiator to have a high-impedance characteristic.

Optionally, the length of the first radiator is less than or equal to ¼ wavelength of the operating frequency.

Optionally, the length of the first radiator is less than or equal to ⅛ wavelength of the operating frequency.

It may be understood that, a smaller length of the radiator indicates a smaller maximum current amplitude difference on the radiator. In this example, when a length (or an electrical length of the first radiator) of the first radiator is less than ¼ wavelength or ⅛ wavelength, the maximum current amplitude difference may be adjusted to be within a small range, thereby obtaining a better radiation effect.

Optionally, the differential mode feed structure includes a first feed source and a second feed source, a first electrode of the first feed source is coupled to the first feed point, and a second electrode of the second feed source is coupled to the second feed point. The first electrode is a positive electrode, and the second electrode is a negative electrode. Alternatively, the first electrode is a negative electrode, and the second electrode is a positive electrode.

Optionally, the differential mode feed structure includes a third feed source, a first electrode of the third feed source is coupled to the first feed point, the first electrode of the third feed source is coupled to the second feed point through a phase inversion component, and the phase inversion component is configured to provide a phase inversion function of 180 degrees.

In this way, excitation of the first radiator in this application can be implemented through either a differential mode feed structure with a single feed source or a differential mode feed structure with double feed sources.

Optionally, a match circuit is disposed between the differential mode feed structure and the first radiator, and the match circuit is configured to adjust the feed signal outputted by the differential mode feed structure to the high-impedance port characteristic.

Optionally, when the antenna operates, the antenna operates in a 0.5-time wavelength mode. Therefore, the antenna may operate in a fundamental mode.

Optionally, when the antenna operates, a maximum current amplitude difference on the first radiator is less than a second value, the second value is a maximum current amplitude difference on a radiator when a dipole antenna operates, and a length of the radiator of the dipole antenna is the first value.

Optionally, the first radiator is in a stripe shape, and a straight line on which a long side of the first radiator is located is parallel to a reference ground.

Optionally, the first radiator includes a first part, a second part, and a third part that are connected in sequence, the first part is perpendicular to a reference ground, the third part is perpendicular to the reference ground, and the second part is disposed between the first part and the third part.

Optionally, a ground stub is further included at a middle position of the first radiator.

In the foregoing example, structural implementations of several different radiators are provided. It may be understood that in any implementation, an electrical length of the radiator may be less than ½ operating wavelength.

Optionally, the first radiator is divided into at least two radiation units by at least one slot. Two ends of each radiation unit are connected to the two signal output ends of the differential mode feed structure respectively. Output ends of differential mode feed structures connected to a same side of any two radiation units have a same polarity.

Optionally, a size of the slot is included in a range of [0.1 mm, 5 mm].

In this way, the radiator is divided into a plurality of radiation units by a slot, so that a maximum current amplitude difference on each radiation unit can be further reduced, thereby improving overall radiation performance of the antenna.

Optionally, at least one capacitor is disposed in series to the first radiator. When a plurality of capacitors are connected in series to the first radiator, at least part of the first radiator is included between any two of the capacitors.

In the example, based on an energy storage characteristic of the capacitor, the maximum current amplitude difference on the radiator is further reduced. It may be understood that when a plurality of capacitors are connected in series to the first radiator, any two of the capacitors may be connected to each other. For example, any two of the capacitors may be connected by part of the first radiator. In this way, better adjustment of the maximum current amplitude difference is implemented. A large quantity of capacitors indicates a better corresponding effect.

According to a second aspect, a terminal antenna is provided, and the antenna is used in an electronic device. The antenna includes a first radiator, a length of the first radiator is a first value, and the first value corresponds to ½ wavelength of an operating frequency of the antenna. A first feed point and a second feed point are disposed at two ends of the first radiator respectively, the first feed point and the second feed point are connected to two signal output ends of a differential mode feed structure respectively, the two signal output ends have different polarities, and the two signals are equi-amplitude phase-inverted signals.

Optionally, a feed signal outputted by the differential mode feed structure and then inputted to the first radiator has a high-impedance port characteristic, and the high-impedance port characteristic is implemented by connecting a capacitor in series.

In the example, a new feed form, for example, a high-impedance differential mode feed being disposed at two ends of a radiator, is provided. Based on the feed form, excitation of a 0.5-time wavelength mode of a dipole antenna can also be implemented.

According to a third aspect, an electronic device is provided, and the terminal antenna provided in any one of the first aspect or the possible designs of the first aspect or the terminal antenna provided in the second aspect is disposed in the electronic device. When transmitting or receiving a signal, the electronic device transmits or receives the signal through the terminal antenna.

It should be understood that the technical features of the technical solutions provided in the second aspect and the third aspect above can correspond to the solutions provided in the first aspect and the possible designs of the first aspect, and therefore similar beneficial effects can be achieved. Details are not described herein.

### BRIEF DESCRIPTION OF DRAWINGS

FIG. 1 is a schematic diagram of an antenna link in an electronic device;

FIG. 2 is a schematic feed diagram of a dipole antenna;

FIG. 3 is a schematic feed diagram of a dipole antenna;

FIG. 4 is a schematic diagram of a terminal antenna solution according to an embodiment of this application;

FIG. 5 is a schematic diagram of a distribution of eigenmode currents of a dipole antenna according to an embodiment of this application;

FIG. 6 is a schematic diagram of a distribution of current amplitudes of a dipole antenna according to an embodiment of this application;

FIG. 7 is a schematic diagram of a distribution of current amplitudes of a dipole antenna with a differential mode feed at two ends according to an embodiment of this application;

FIG. 8 is a schematic diagram of matching of a dipole antenna with a differential mode feed at two ends according to an embodiment of this application;

FIG. 9 is a schematic diagram of a current amplitude difference of a dipole antenna according to an embodiment of this application;

FIG. 10 is a schematic diagram of a current amplitude difference of an antenna with a differential mode feed at two ends according to an embodiment of this application;

FIG. 11 is a schematic diagram of simulation of an antenna solution according to an embodiment of this application;

FIG. 12 is a schematic diagram of S11 simulation in an unmatched state according to an embodiment of this application;

FIG. 13 is a schematic diagram of S-parameter simulation in a high-impedance matching state of a port according to an embodiment of this application;

FIG. 14 is a schematic diagram of current distribution simulation in a high-impedance matching state of a port according to an embodiment of this application;

FIG. 15 is a schematic diagram of magnetic field simulation in a high-impedance matching state of a port according to an embodiment of this application;

FIG. 16 is a schematic diagram of simulation of a pattern in a high-impedance matching state of a port according to an embodiment of this application;

FIG. 17 is a schematic diagram of simulation of an antenna solution according to an embodiment of this application;

FIG. 18 is a schematic structural diagram of two terminal antennas according to an embodiment of this application;

FIG. 19 is a schematic structural diagram of a terminal antenna according to an embodiment of this application;

FIG. 20 is a schematic structural diagram of a terminal antenna according to an embodiment of this application;

FIG. 21 is a schematic structural diagram of a terminal antenna according to an embodiment of this application; and

FIG. 22 is a schematic structural diagram of a terminal antenna according to an embodiment of this application.

### DESCRIPTION OF EMBODIMENTS

Currently, most electronic devices can provide a wireless communication function.

For example, with reference to FIG. 1, an example in which an electronic device is a mobile phone is used. At least one antenna connected to a feed source may be disposed in the electronic device. The antenna may implement an electromagnetic wave radiation or receiving function under excitation of the feed source, so that the electronic device provides the foregoing wireless communication function.

It may be understood that antennas disposed in the electronic device may be in various forms. However, these different antenna forms may all be derived based on several basic antennas. The basic antennas may include a dipole antenna, a monopole antenna, a slot antenna, and the like.

Antenna forms that radiate through a radiator, for example, a dipole antenna and a monopole antenna, may also be referred to as wire antennas. Correspondingly, an antenna form that radiates through a slot formed by a metal material, for example, a slot antenna, may also be referred to as a slotted antenna.

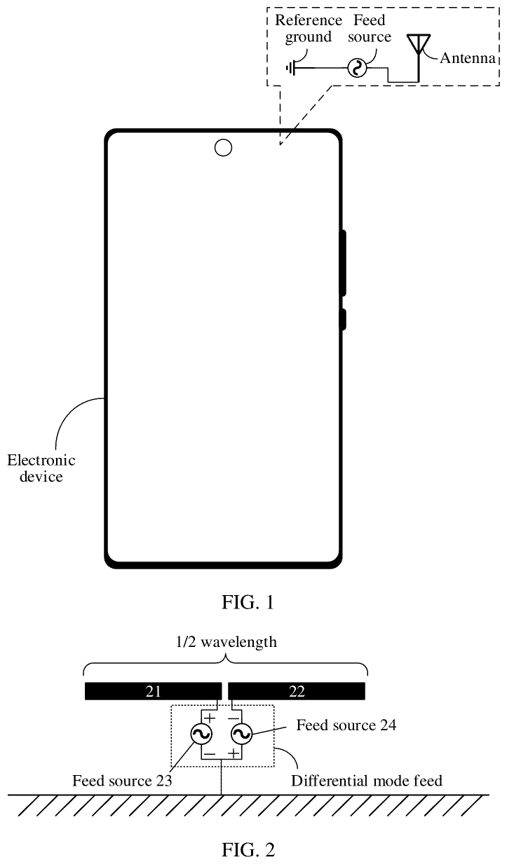

For example, FIG. 2 shows an example of an excitation manner of a dipole antenna. In the example, radiators of the dipole antenna may include a radiator 21 and a radiator 22 that have lengths corresponding to a ¼ wavelength size of an operating frequency band. Long sides of the radiator 21 and the radiator 22 may be disposed in parallel, for example, disposed at a same straight line. Feed points may be disposed at ends close to each other of the radiator 21 and the radiator 22 respectively.

In this example, excitation of the dipole antenna can be implemented by feeding the feed points on the radiator 21 and the radiator 22 respectively in an equi-amplitude phase-inverted differential mode (DM) feed form. For example, as shown in FIG. 2, the differential mode feed may include two feed sources, for example, a feed source 23 and a feed source 24. A positive electrode of one feed source (for example, the feed source 23) in the differential mode feed may be connected to the feed point of one radiator (for example, the radiator 21). A negative electrode of the other feed source (for example, the feed source 24) in the differential mode feed may be connected to the feed point of the other radiator (for example, the radiator 22). Ends of the two feed sources away from the radiators are respectively coupled to a ground. In this way, when the antenna operates in a fundamental mode, current distributions in a same direction may be formed on the radiator 21 and the radiator 22.

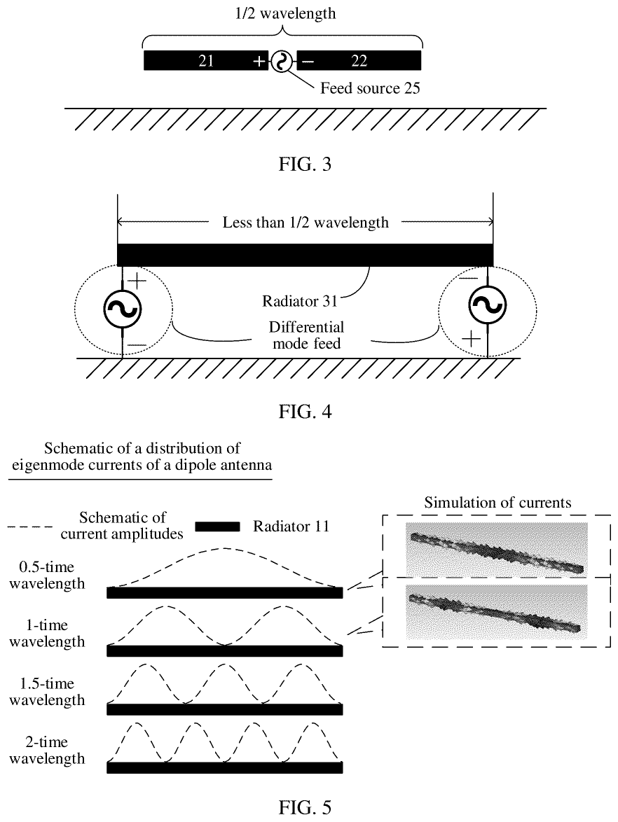

As shown in FIG. 3, a conventional excitation manner of another dipole antenna is further provided. In the example, radiators of the dipole antenna may include a radiator 21 and a radiator 22 that have lengths corresponding to a ¼ wavelength size of an operating frequency band. Long sides of the radiator 21 and the radiator 22 may be disposed in parallel, for example, disposed at a same straight line. Feed points may be disposed at ends close to each other of the radiator 21 and the radiator 22 respectively.

In this example, positive and negative electrodes of a feed source may be coupled to the feed points on the radiator 21 and the radiator 22 respectively. For example, a positive electrode of a feed source 25 may be coupled to the feed point on the radiator 21, and a negative electrode of the feed source 25 may be coupled to the feed point on the radiator 22. In this way, when the antenna operates in a fundamental mode, current distributions in a same direction similar to those on the antenna shown in FIG. 2 may be formed on the radiator 21 and the radiator 22.

With reference to the foregoing descriptions, the excitation of the dipole antenna can be implemented in the excitation manner shown in FIG. 2 or FIG. 3. Therefore, when disposed in an electronic device, the dipole antenna or another antenna form derived based on the dipole antenna can operate in a fundamental mode (for example, a ½ wavelength mode) or a higher-order mode (for example, a 1-time wavelength mode or a 3/2-time wavelength mode) in the excitation manner shown in FIG. 2 or FIG. 3, to cover the operating frequency band.

It may be understood that to enable the dipole antenna to operate normally, it needs to be ensured that a length of the radiator corresponds to ½ wavelength of the operating frequency band. A smaller operating frequency band corresponds to a larger wavelength, and poses higher requirements on the length of the radiator.

In this way, a new antenna form is required to provide an antenna with better radiation performance and a smaller size.

To resolve the foregoing problem, embodiments of this application provide a terminal antenna form. The antenna may have a radiator with a size less than ½ wavelength and can provide good radiation performance.

For example, FIG. 4 is a schematic of a terminal antenna according to an embodiment of this application. In the example, the antenna may use a differential mode feed form, and is fed at two ends of a radiator, to excite operation of the antenna. In addition, the radiator of the antenna may include a radiator 31 with a size less than ½ wavelength of an operating frequency band. The differential mode feed may be described as that equi-amplitude phase-inverted feed signals are simultaneously fed at two feed points of the antenna to excite the antenna. In this example, the two feed points of the antenna may be disposed at end portions of two ends of the radiator 31.

The implementation and effects of the terminal antenna solution provided in the embodiments of this application will be described below in detail with reference to the accompanying drawings.

A solution mechanism of a differential mode feed in the antenna solution provided in the embodiments of this application is exemplarily described below first from the perspective of an antenna eigenmode.

It should be understood that a radiator in any form has respective corresponding eigenmode distributions in different wavelength modes. For example, an eigenmode distribution includes a distribution of eigenmode currents.

For example, FIG. 5 is a schematic of a distribution of eigenmode currents of a dipole antenna. The dipole antenna is shown in FIG. 2 or FIG. 3. In this example, for example, a radiator of the antenna is a radiator 11, a length of which corresponds to ½ wavelength of an operating frequency band. In the example shown in FIG. 5, distributions of eigenmode currents of the dipole antenna in a ½-time wavelength mode (a fundamental mode), a 1-time wavelength mode, a 1.5-time wavelength mode, and a 2-time wavelength mode are provided. A schematic current amplitude curve represents a current distribution on the radiator. As analyzed from the figure, when the curve is farther away from the radiator, a corresponding current amplitude is larger, and a current is larger. In contrast, when the schematic current amplitude curve is closer to the radiator, a corresponding current amplitude is smaller, and a current is smaller.

As shown in FIG. 5, in a ½-time wavelength (namely, a half wavelength) mode, the radiator of the antenna may include two points with a small current amplitude (referred to as a point with a small current hereinafter) and one point with a large current amplitude (referred to as a point with a large current hereinafter). The point with a large current amplitude may be located at a middle position of the radiator, and the points with a small current amplitude may be located at two ends of the radiator.

In the 1-time wavelength mode, the radiator of the antenna may include three points with a small current and two points with a large current. The points with a large current are respectively located at middle positions of a left half part and a right part of the radiator. Positions of the points with a small current may include the two ends of the radiator and a middle position between the two points with a large current.

In the 1.5-time wavelength mode, the radiator of the antenna may include four points with a small current and three points with a large current. The two ends of the radiator are points with a small current. The points with a small current and the points with a large current are alternately distributed on the radiator successively.

In the 2-time wavelength mode, the radiator of the antenna may include five points with a small current and four points with a large current. The two ends of the radiator are points with a small current. The points with a small current and the points with a large current are alternately distributed on the radiator successively.

With reference to features of the distributions of eigenmode currents in the foregoing different modes, in a ½M-time (that is, ½×M times, where M is an odd number) wavelength mode, the middle position of the radiator is a point with a large current. Correspondingly, in an N-time wavelength mode, the middle position of the radiator is a point with a small current. N is a positive integer.

It needs to be noted that in this application, a position relationship between the point with a large current and the point with a small current cannot be used to determine a current flow direction. For example, in some cases, current intensity may periodically change, and the current flow direction may be unchanged. In some other cases, there may be a phase inversion point in the current flow direction as current intensity periodically changes.

A corresponding feed source may be disposed with reference to the foregoing distributions of eigenmode currents of the dipole antenna in different modes shown in FIG. 5 to implement excitation of a corresponding mode.

For example, excitation of a corresponding wavelength mode on the radiator can be implemented by connecting a low-impedance (for example, less than 100 ohms) feed source to a point with a large current corresponding to the eigenmode distribution. For example, the low-impedance feed source may include a 50-ohm feed source or a 75-ohm feed source.

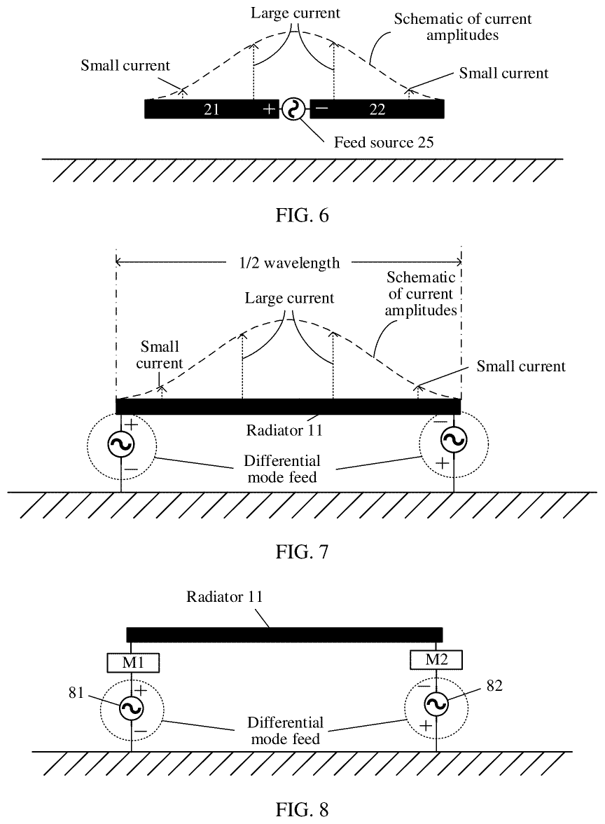

For specific modes, a fundamental mode (½-time wavelength) is used as an example. The radiator 11 may be divided at a middle position into two radiators with a size of ¼ wavelength, for example, the radiator 21 and the radiator 22 in the foregoing example. As shown in FIG. 6, a single feed source (for example, a feed source 23) may be connected to a point (for example, between the radiator 21 and the radiator 22) with a large eigenmode current corresponding to the fundamental mode, a differential mode feed may be connected as shown in FIG. 2. In this way, the dipole antenna is excited to operate in the ½-time wavelength mode. In this way, the dipole antenna may generate resonance of a ½ wavelength mode corresponding to an electrical length of the radiator thereof to cover the operating frequency band. In this way, the dipole antenna solution shown in FIG. 2 or FIG. 3 may be obtained.

In the embodiments of this application, based on the distributions of eigenmode currents of the dipole antenna shown in FIG. 5, high-impedance (for example, greater than 100 ohms) differential mode feed sources may be connected to two different points with a small current respectively corresponding to the eigenmode distribution to implement excitation of a corresponding mode. High impedance may be an impedance state corresponding to impedance matching close to an open circuit. For example, the high-impedance feed sources may include a 200-ohm feed source or a 500-ohm feed source.

For example, the fundamental mode is still used as an example. As shown in FIG. 7, high-impedance differential mode feed sources may be connected to points (for example, two ends of the radiator 11) with a small eigenmode current corresponding to the fundamental mode respectively. The two differential mode feed sources may form the differential mode feed structure of the radiator 11. In this way, a current distribution with current intensity large in the middle and small on two sides can be formed on the radiator 11 by arranging a differential mode feed shown in FIG. 7, which is the same as the distribution of eigenmode currents of the fundamental mode shown in FIG. 5. In other words, excitation of the ½ wavelength mode of the dipole antenna can be implemented by arranging the differential mode feed shown in FIG. 7.

It needs to be noted that in the embodiments of this application that the high-impedance feed sources may include any of the following two:
1. a signal source with a high-impedance port characteristic; and
2. a match circuit disposed between a low-impedance feed source and a radiator, a port characteristic of a signal source emitted by the low-impedance feed source being matched to a high impedance through the match circuit. For example, a capacitor or other components may be disposed in series in the match circuit to implement the adjustment of increasing a port impedance.

For example, with reference to FIG. 8, the arrangement of a high-impedance differential mode feed in the embodiments of this application is exemplarily described by using an example in which a high-impedance feed source is obtained through a match circuit. In this example, the differential mode feed structure may include a feed source 81 and a feed source 82 that output equi-amplitude phase-inverted feed signals to a radiator. A match circuit may be disposed between each of the two feed sources that provide equi-amplitude phase-inverted signals and the radiator respectively. For example, a match circuit M1 is disposed between the feed source 81 and one end of the radiator 11. A match circuit M2 is disposed between the feed source 82 and the other end of the radiator 11. Through tuning of the match circuit M1 and the match circuit M2, signals emitted by the feed source 81 and the feed source 82 have high-impedance port characteristics and are connected to the two ends of the radiator 11. In this way, the arrangement of the high-impedance differential mode feed at the two ends of the radiator (for example, the radiator 11) of the dipole antenna is implemented.

It may be understood that the foregoing FIG. 7 and FIG. 8 are merely schematics of excitation of the fundamental mode of the dipole antenna. A higher-order mode of another mode may be effectively excited at a point with a small eigenmode current of a corresponding mode through the high-impedance differential mode feed provided in the embodiments of this application. For an arrangement manner thereof, refer to the descriptions of the foregoing FIG. 7 and FIG. 8. Details are not described herein again.

In this way, the high-impedance differential mode feed has a feed mechanism different from that of an ordinary feed form, so that excitation manners of an existing antenna are more diversified. For a feed in another derived antenna form corresponding to the dipole antenna, refer to the solution of the high-impedance differential mode feed at a point with a small eigenmode current provided in this application for flexible selection of a feed mechanism. In the following example, the high-impedance differential mode feed is referred to as a differential mode feed for short.

In the foregoing example, the solution mechanism of the differential mode feed provided in the embodiments of this application is exemplarily described from the perspective of an antenna eigenmode. Implementation of an antenna solution with a smaller size (for example, less than ½ wavelength) provided in the embodiments of this application is described below based on the mechanism of the differential mode feed.

It may be understood that with reference to the distribution of eigenmode currents shown in FIG. 5, when the length of the radiator corresponds to ½ wavelength of the operating frequency band, during operation in any mode, currents with different intensity may be distributed on the radiator.

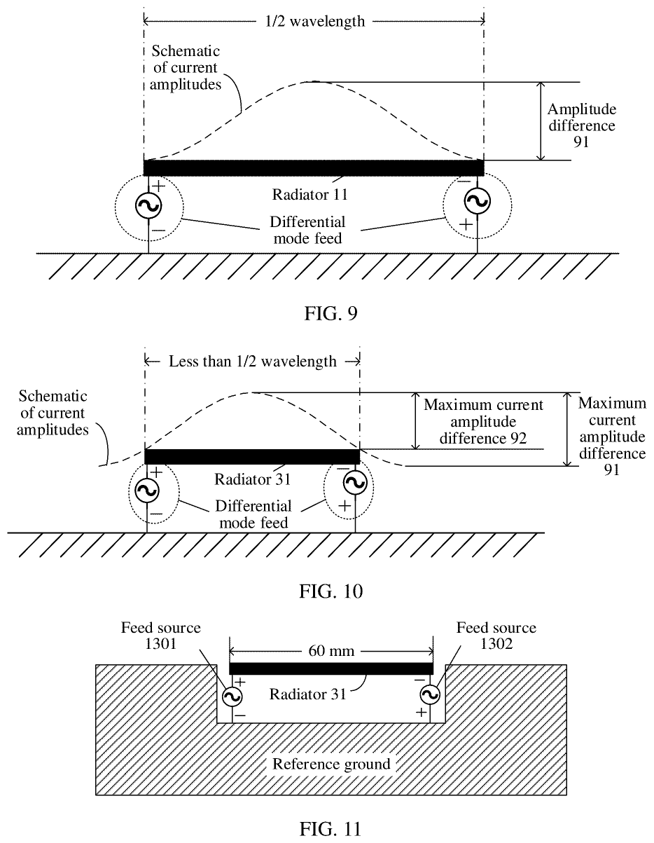

FIG. 9 is a schematic of a distribution of current intensity on the radiator when the dipole antenna operates in the fundamental mode (i.e., the ½ wavelength mode). In the example, the dipole antenna may be excited through a differential mode feed disposed at two ends.

As shown in FIG. 9, when the dipole antenna operates, a current amplitude at a middle position of the radiator 11 with the length corresponding to ½ wavelength of the operating frequency band is the largest, and current amplitudes at the two ends are the smallest.

In this case, in the state, a maximum current amplitude difference of the distribution on the radiator 11 is an amplitude difference 91 shown in FIG. 9. It may be understood that when the maximum current amplitude difference is larger, an energy distribution in a nearby space of the radiator presents a trend of converging toward a middle position (for example, a middle position in a region between the radiator 11 and a reference ground). The trend of energy converging in the space is clearly not beneficial to radiation of the antenna. For example, as energy converges in the space, a dielectric loss in a region (for example, a nearby space close to the middle position of the radiator 11) with high energy density significantly increases, and as a result the radiation performance (for example, radiation efficiency, and system efficiency) of the antenna is reduced.

In the embodiments of this application, the length of the radiator disposed between two feed sources of the differential mode feed may be less than ½ wavelength, so that the maximum current amplitude difference of the distribution of currents on the radiator is reduced. In this way, the foregoing trend of energy converging toward the middle position in the region between the radiator 11 and the reference ground is avoided, thereby improving the radiation performance of the antenna.

For example, with reference to FIG. 10, in the antenna solution provided in the embodiments of this application, the length of the radiator of the antenna may be less than ½ wavelength corresponding to the operating frequency band. For example, the radiator may be a radiator 31 shown in FIG. 10. Feed sources are still disposed at two ends of the radiator 31. It should be understood that in an operating state of the fundamental mode, regardless of the length of the radiator, a current intensity distribution conforms to a characteristic that current intensity is large in the middle and small on two sides. In this case, in this example, as the length of the radiator becomes less than ½ wavelength of the operating frequency band, a corresponding schematic current amplitude curve also moves downward based on the example shown in FIG. 9. Alternatively, the schematic current amplitude curve shown in FIG. 10 corresponds to a part in the middle of the curve shown in FIG. 9. In this way, in the example shown in FIG. 10, a maximum current amplitude difference of currents distributed in an effective radiation region correspondingly decreases from a maximum current amplitude difference 91 to a maximum current amplitude difference 92. The maximum current amplitude difference 91 is a maximum current amplitude difference of currents distributed in an effective radiation region of the radiator 11 with the length corresponding to ½ wavelength of the operating frequency band when the dipole antenna operates. The maximum current amplitude difference 92 is a maximum current amplitude difference of currents distributed in an effective radiation region of the radiator 11 with the length of the radiator being less than ½ wavelength of the operating frequency band.

In other words, in the example shown in FIG. 10, as an amplitude difference between current intensity on the radiator becomes smaller, an energy distribution in the nearby space of the radiator tends to be more dispersed. In this way, the radiation performance of the antenna can be effectively improved.

In the foregoing FIG. 9 and FIG. 10, an implementation mechanism of the antenna solution provided in the embodiments of this application is described from the perspective of current intensity. In the example shown in FIG. 10, a length of the radiator 31 is less than ½ operating wavelength. It may be understood that as the length of the radiator decreases, a corresponding maximum current amplitude difference is smaller. For example, when the length of the radiator is less than or equal to ¼ operating wavelength or the length of the radiator is less than or equal to ⅛ operating wavelength, the maximum current amplitude difference on the radiator may be less than a preset amplitude threshold. In this case, it may also be approximately considered that when the length of the radiator is less than or equal to ¼, the currents on the radiator tend to be uniform, and corresponding radiation performance is better. It may be understood that, when the currents on the radiator tend to be uniform, an energy distribution in the nearby space (for example, between the radiator and the reference) of the radiator is more uniform, so that a large loss caused by energy concentration does not occur. In other words, in the embodiments of this application, the maximum current amplitude difference being small corresponds to the currents on the radiator tending to be uniform, so that the radiation performance of the antenna can be improved.

An antenna solution of a high-impedance differential mode feed with a size of a radiator less than ½ wavelength provided in the embodiments of this application during operation is described below with reference to a schematic of specific simulation.

For example, FIG. 11 is a schematic diagram of a simulation model of an antenna solution according to an embodiment of this application. In this example, the antenna may include one radiator 31. A length of the radiator 31 may be less than ½ wavelength of an operating frequency band.

For example, an example in which the operating frequency band is higher than 700 MHz (for example, 800 MHz), a dielectric constant (DK) corresponding to a material of the antenna is 3.2, and a dissipation factor (DF) corresponding to the material of the antenna is 0.01 is used. A size of the radiator corresponding to ½ wavelength may be close to 120 mm. The length of the radiator 31 may be less than 120 mm. For example, the length of the radiator 31 may be equal to ¼ wavelength of the operating frequency band, for example, is set to 60 mm.

As shown in FIG. 11, a feed source 1301 and a feed source 1302 may be disposed at two ends of the radiator 31 respectively. The feed source 1301 and the feed source 1302 may form the differential mode feed structure. For example, a positive electrode of the feed source 1301 may be coupled to one end of the radiator 31, and a negative electrode of the feed source 1301 may be grounded. A negative electrode of the feed source 1302 may be coupled to the other end of the radiator 31, and a positive electrode of the feed source 1302 may be grounded.

It needs to be noted that with reference to the foregoing descriptions of the high-impedance differential mode feed, in some embodiments of this application, a corresponding match circuit (not shown in FIG. 11) may be disposed between the positive electrode of the feed source 1301 and the radiator 31 and between the negative electrode of the feed source 1302 and the radiator 31 respectively. Through tuning of the match circuits, the feed source 1301 and the feed source 1302 may transmit feed signals having high-impedance port characteristics to the radiator 31.

In different scenarios, components in the match circuits configured to provide high-impedance port characteristics may be different, so that a resonance position excited on the radiator 31 can correspondingly cover operating frequency bands in different scenarios.

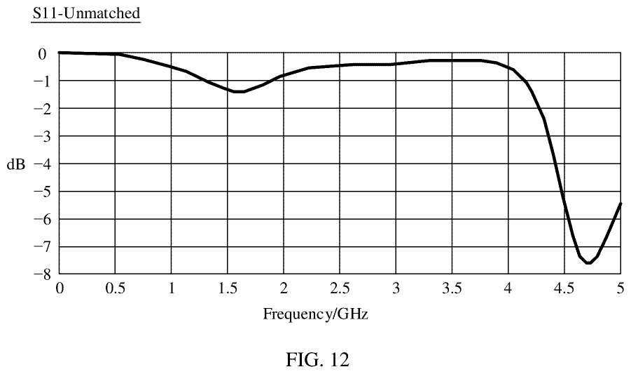

For example, FIG. 12 is a schematic diagram of S11 generated when the antenna shown in FIG. 11 is excited by the differential mode feed structure without matching.

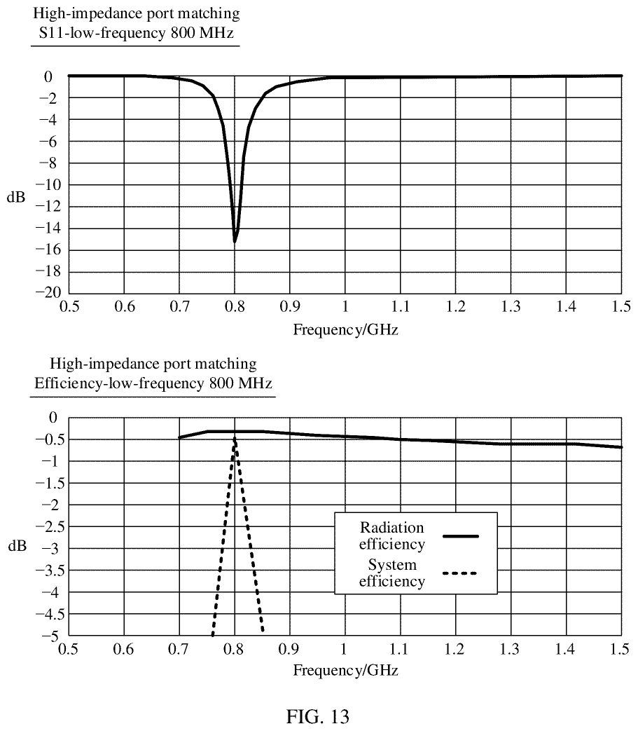

FIG. 13 is a schematic of an effect of high-impedance port matching. As shown in FIG. 13, through the port matching in the example, resonance in the excitation of the antenna can be tuned to cover 800 MHz. For a schematic of efficiency simulation shown in FIG. 13, radiation efficiency of the antenna near 800 MHz at most exceeds −0.5 dB, and a peak value of system efficiency also exceeds −0.5 dB.

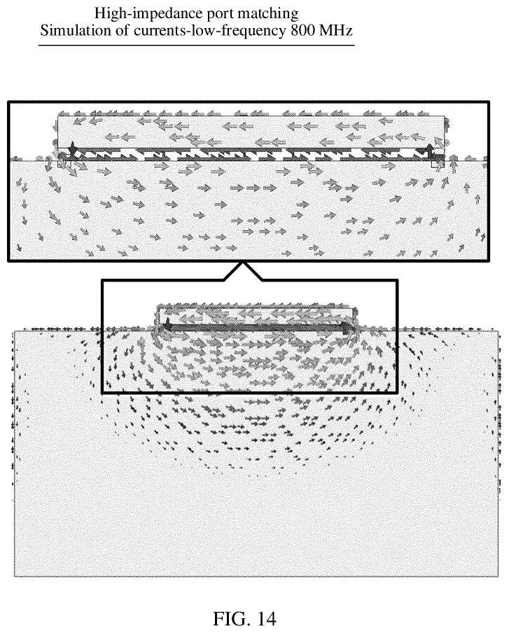

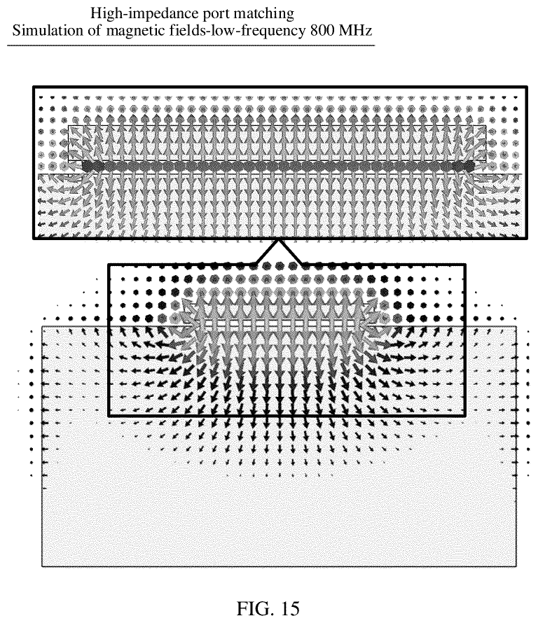

FIG. 14 is a schematic of simulation of currents on the radiator and a surrounding floor when the antenna operates. An arrow direction indicates a current flow direction at a current moment, and a darker arrow corresponds to a larger current amplitude. It can be seen that, through a differential mode feed provided in the embodiments of this application, in-phase currents can be effectively excited on the radiator. Current intensity on the radiator has no significant change, which corresponds to the maximum current amplitude difference on the radiator being reduced in the foregoing descriptions. FIG. 15 is a schematic of simulation of magnetic fields on the radiator and the surrounding floor when the antenna operates. An arrow direction indicates a direction of magnetic induction lines at a current moment, and a darker arrow corresponds to larger magnetic field intensity. It can be seen that, through the differential mode feed provided in the embodiments of this application, magnetic fields with close excitation intensity can be excited in a surrounding space (for example, in a region between the radiator and the reference ground) of the radiator for radiation, thereby reducing a maximum magnetic field amplitude difference corresponding to the maximum current amplitude difference on the radiator.

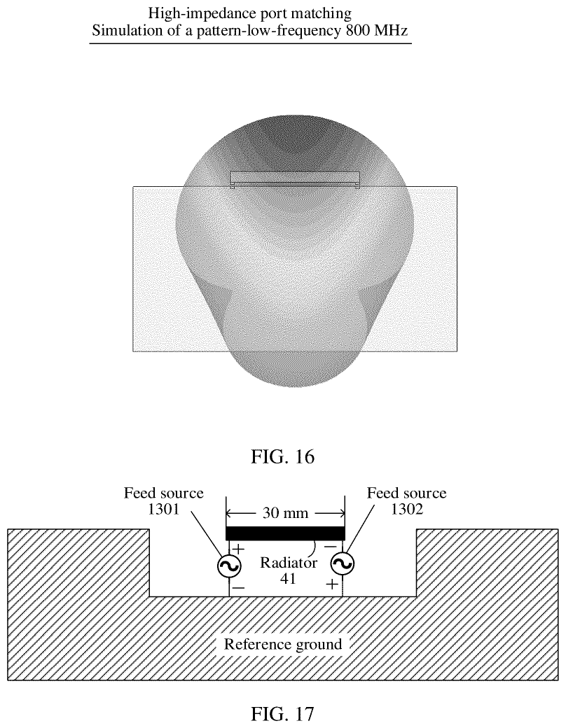

Therefore, based on the simulation from perspectives of currents and magnetic fields shown in FIG. 14 and FIG. 15, it can indicate that the antenna solution provided in the embodiments of this application can implement energy excitation with a small amplitude difference in the nearby space of the radiator of the antenna through the differential mode feed connected to two ends of the radiator (for example, the radiator 31), thereby improving radiation performance. In addition, FIG. 16 further provides a schematic of simulation of a pattern of an antenna solution operating at 800 MHz according to an embodiment of this application.

In the foregoing descriptions of FIG. 11 to FIG. 16, an example in which the length of the radiator is equal to ¼ operating wavelength is used. As shown in FIG. 17, an example of a simulation model in which a length of a radiator is 30 mm, i.e., is equal to ⅛ operating wavelength is shown. It may be understood that, in the example, the length of the radiator is further reduced, a corresponding maximum current amplitude difference is smaller, and a distribution of currents on the radiator is more uniform, so that radiation performance is better. During specific implementation, as the length of the radiator decreases, due to a reduced area of a radiation dielectric, a resonance bandwidth may slightly deteriorate. Therefore, during specific implementation, the length of the radiator may be flexibly selected based on required radiation performance and bandwidth requirements. In some implementations, a plurality of antenna solutions with short lengths shown in FIG. 17 may be disposed to implement coverage of a same frequency band, so that an overall coverage bandwidth is improved.

With reference to the foregoing descriptions of FIG. 10 to FIG. 17, a person skilled in the art should have a detailed understanding of an operation mechanism and an effect of the antenna solution (for example, the antenna solution shown in FIG. 4) provided in embodiments of this application.

Embodiments of this application further provide several examples of antenna forms different from the structure shown in FIG. 4.

For example, FIG. 18 is an implementation form of some other terminal antennas according to an embodiment of this application. Implementations provided in this example have a similar structural feature to the antenna shown in FIG. 4. A length of a radiator is less than ½ wavelength of an operating frequency band, and two feed sources of the differential mode feed are coupled to two ends of the radiator respectively. The two feed sources of the differential mode feed may be connected to the radiator in a high-impedance form to feed the antenna.

As shown by 1910 in FIG. 18, a radiator of an antenna in the example may include a radiator 1911. The radiator 1911 may include a first part parallel (or approximately parallel) to a floor. An electrical length of the first part may be less than ½ wavelength of the operating frequency band. A stub 1912 may be disposed at a middle position of the first part, i.e., a point with the largest current in a fundamental mode, as a second part of the radiator 1911. One end of the second part is connected to the middle position of the first part, and the other end of the second part is grounded. Two feed sources of a high-impedance differential mode feed are disposed at two ends of the first part respectively.

1920 shown in FIG. 18 shows a schematic of a structure of another antenna. In the example, a radiator of the antenna may include a radiator 1921. An electrical length of the radiator 1921 may be less than ½ wavelength of the operating frequency band. The radiator 1921 may be provided with two symmetrical L-shaped bent structures. The two L-shaped bent structures divide the radiator 1921 into a first part parallel (or approximately parallel) to a floor and a second part and a third part that are perpendicular (or approximately perpendicular) to the floor. The first part is located between the second part and the third part, and the second part, the first part, and the third part are connected end to end. One end at the second part and one end at the third part of the radiator 1921 are on a same side of the first part. The high-impedance differential mode feed is fed to the two ends of the radiator 1921 for excitation.

It may be understood that, the two structures shown in FIG. 18 are merely examples, and the antenna solution provided in embodiments of this application may have other variants. In various variant structures, antenna forms in which the electrical length of the radiator is less than ½ wavelength of the operating frequency band and the two ends are connected to the high-impedance differential mode feed shall all fall within the scope of the technical solutions provided in the embodiments of this application.

In this way, an energy distribution with a small maximum electric field amplitude difference between the radiator of the antenna and the floor can be obtained by using an antenna arrangement having a size less than ½ wavelength of the operating frequency band and a high-impedance differential mode feed connected to two ends, so that better radiation performance is obtained.

It needs to be noted that, in some implementations, the high-impedance differential mode feed may be disposed on the radiator instead of being completely disposed on an end surface of the radiator. In this way, the foregoing technical effect can be obtained in the high-impedance differential mode feed of the radiator and the reference ground.

In some other embodiments of this application, based on the foregoing antenna structures shown in FIG. 4 or FIG. 18, further optimized design may be performed, to obtain better radiation performance.

For example, in some embodiments, the antenna structure shown in FIG. 4 is used as an example, and the radiator 31 may be divided into a plurality of radiation units (for example, two or more radiation units). The radiators of the plurality of radiation units are disposed in parallel. For example, long sides of the radiators of the plurality of radiation units are disposed at a same straight line. Any two adjacent radiation units of the plurality of radiator units are separated through a slot. A size of the slot may be [0.1 mm to 5 mm]. Two ends of each radiation unit are connected to the high-impedance differential mode feed in the foregoing embodiment respectively. Corresponding to the radiator 31, a total length of the plurality of radiation units is less than ½ wavelength of the operating frequency band.

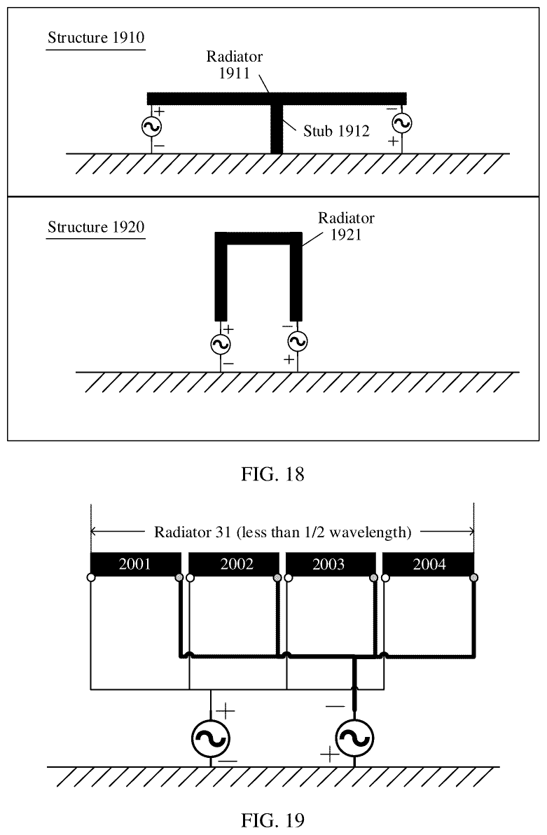

For example, an example in which the radiator 31 is divided into four radiation units is used. FIG. 19 is a schematic diagram of another antenna solution according to an embodiment of this application. In this example, the radiation units may include a radiator 2001, a radiator 2002, a radiator 2003, and a radiator 2004. Long sides of the radiator 2001, the radiator 2002, the radiator 2003, and the radiator 2004 are disposed at a same straight line, and a total length is less than ½ wavelength of the operating frequency band. As shown in FIG. 19, ends on a left side of the radiator 2001, the radiator 2002, the radiator 2003, and the radiator 2004 are coupled to one feed source in a differential mode feed respectively. Correspondingly, ends on a right side of the radiator 2001, the radiator 2002, the radiator 2003, and the radiator 2004 are coupled to the other feed source in the differential mode feed respectively. In this way, a differential mode feed for each radiation unit is implemented. During specific implementation, a match circuit may be disposed at a link between each radiation unit and a feed source, to match a high-impedance port characteristic of a feed signal.

It may be understood that, with reference to the schematic descriptions of FIG. 10, after the radiator 31 is divided into the plurality of radiation units, a high-impedance differential mode feed is connected to each radiation unit, so that a maximum current amplitude difference smaller than that on the radiator 31 is obtained on each radiation unit respectively. Therefore, when the antenna solution formed by the plurality of radiation units is operates, a maximum current amplitude difference between the radiator in the antenna solution is smaller, so that the radiation performance can be improved more significantly. Based on the descriptions, a larger quantity of radiation units obtained through division indicates a clearer corresponding improvement.

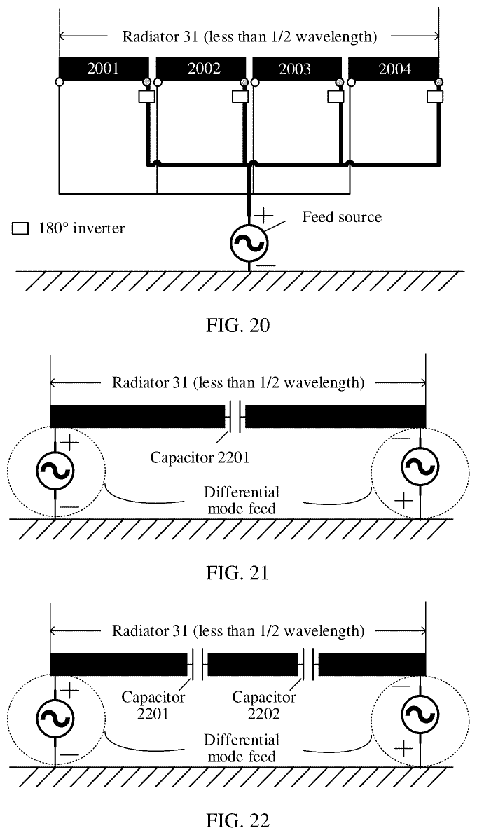

The foregoing examples are all described by using an example in which a differential mode feed is implemented through two feed sources. It may be understood that in some other embodiments, the technical solutions provided in the embodiments of this application can also be implemented through a single feed source in combination with a component with a phase inversion function. For example, the antenna structure shown in FIG. 19 is used as an example. FIG. 20 is a schematic composition diagram of another antenna according to an embodiment of this application. In this example, an example in which the radiator 31 is divided into four radiation units is still used. As shown in FIG. 20, one feed source may be disposed in the antenna solution. For example, the feed source may be a high-impedance feed source. One end of the feed source is grounded, and the other end may be coupled to same ends of a radiator 2001 to a radiator 2004. For example, a positive electrode of the feed source may be coupled to right ends of the radiator 2001 to the radiator 2004 respectively. The positive electrode of the feed source may be coupled to left ends of the radiator 2001 to the radiator 2004 respectively through a 180° inverter. In this way, an effect of feeding equi-amplitude phase-inverted differential mode signals at two ends can be implemented on each radiation unit. Similar to the descriptions of the solution shown in FIG. 19, in the antenna solution shown in FIG. 20, a maximum current amplitude difference between the radiator in the antenna solution is smaller, so that the radiation performance can be improved more significantly. Based on the descriptions, a larger quantity of radiation units obtained through division indicates a clearer corresponding improvement.

With reference to the descriptions of FIG. 19 and FIG. 20, a current distribution with a smaller maximum current amplitude difference can be obtained on a radiator in a manner of designing a plurality of radiation units of a differential mode feed, thereby improving the radiation performance of the antenna.

In some other embodiments of this application, the foregoing objectives can be implemented in other manners.

For example, FIG. 21 is a schematic diagram of another antenna solution according to an embodiment of this application. An example in which a variation is made based on the antenna solution shown in FIG. 4 is used.

As shown in FIG. 21, in the antenna solution, a radiator of the antenna may be a radiator 31 with an electrical length less than ½ wavelength of an operating frequency band. Two ends of the radiator 31 may be connected to a high-impedance differential mode feed respectively. In this example, at least one capacitor may be connected in series to the radiator 31. For example, in the example in FIG. 21, an example in which a capacitor 2201 is connected in series is used. In this way, a current distribution with a smaller maximum current amplitude difference is obtained on the radiator 31.

It may be understood that the capacitor 2201 may have an energy storage characteristic. Under excitation of a differential mode feed, a current generated on the radiator 31 may charge energy in the capacitor 2201. In this way, when a phase of a feed signal changes as time elapses, due to the presence of the capacitor 2201, a current change at a position close to the capacitor 2201 on the radiator 31 has a significant delay compared with a change in the feed signal. For example, when a current at the feed source increases, a current near a position of the capacitor 2201 still does not decrease. For another example, when the current at the feed source decreases, the current near the position of the capacitor 2201 still does not increase. In this way, a distribution of current amplitudes on the entire radiator 31 no longer conforms to the characteristic of having current intensity large in the middle and small on two sides shown in FIG. 10. After the capacitor 2201 is added, the distribution of current amplitudes on the radiator 31 is more regionally balanced. That is, current amplitudes at the two ends of the radiator 31 are relatively increased, and a current amplitude near the position of the capacitor 2201 disposed on the radiator 31 is relatively decreased. In this way, a current amplitude difference is further reduced on the radiator 31, that is, a current distribution with a smaller maximum current amplitude difference is obtained. Corresponding to a magnetic field, a magnetic field distribution with a smaller maximum magnetic field amplitude difference can be obtained between the radiator 31 and the reference ground. In this way, based on the antenna solution shown in FIG. 4, better radiation performance is obtained.

It may be understood that a larger quantity of capacitors disposed on the radiator 31 indicates a smaller current amplitude difference on the radiator 31, and corresponding radiation performance of the antenna is higher. For example, as shown in FIG. 22, an example in which two capacitors (for example, a capacitor 2201 and a capacitor 2202) are connected in series to the radiator 31 is used. The capacitor 2201 and the capacitor 2202 may divide the radiator 31 into three parts. The three parts are connected in sequence by the capacitor 2201 and the capacitor 2202. In this way, maximum current amplitude differences are adjusted at corresponding positions on the radiator through the capacitor 2202 and the capacitor 2201, thereby obtaining an overall smaller maximum current amplitude difference.

Although this application is described with reference to specific features and embodiments thereof, it is clear that various modifications and combinations may be made to them without departing from the spirit and scope of this application. Correspondingly, the specification and the accompanying drawings are merely example descriptions of this application defined by the appended claims, and are considered as any of or all modifications, variations, combinations, or equivalents that cover the scope of this application. It is clear that a person skilled in the art can make various modifications and variations to this application without departing from the spirit and scope of this application. This application is intended to cover these modifications and variations of this application provided that they fall within the scope of protection defined by the claims of this application and their equivalent technologies.

1. An antenna, wherein the antenna is used in an electronic device;
the antenna comprises a first radiator, a length of the first radiator is less than or equal to a first value, and the first value corresponds to ½ wavelength of an operating frequency of the antenna; and
a first feed point and a second feed point are disposed at two ends of the first radiator respectively, the first feed point and the second feed point are connected to two signal output ends of a differential mode feed structure respectively, the two signal output ends have different polarities, and the two signals output from the two signal output ends are equi-amplitude phase-inverted signals.

2. The antenna according to claim 1, wherein the length of the first radiator is less than or equal to ¼ wavelength of the operating frequency.

3. The antenna according to claim 1, wherein the length of the first radiator is less than or equal to ⅛ wavelength of the operating frequency.

4. The antenna according to claim 1, wherein
the differential mode feed structure comprises a first feed source and a second feed source;
a first electrode of the first feed source is coupled to the first feed point, and a second electrode of the second feed source is coupled to the second feed point; and
the first electrode is a positive electrode, and the second electrode is a negative electrode; or the first electrode is a negative electrode, and the second electrode is a positive electrode.

5. The antenna according to claim 1, wherein
the differential mode feed structure comprises a third feed source; and
a first electrode of the third feed source is coupled to the first feed point, the first electrode of the third feed source is coupled to the second feed point through a phase inversion component, and the phase inversion component is configured to provide a phase inversion function of 180 degrees.

6. The antenna according to claim 1, wherein a feed signal outputted by the differential mode feed structure and then inputted to the first radiator has a high-impedance port characteristic, and the high-impedance port characteristic is implemented by connecting a capacitor in series.

7. The antenna according to claim 6, wherein
a match circuit is disposed between the differential mode feed structure and the first radiator, and the match circuit is configured to adjust the feed signal outputted by the differential mode feed structure to the high-impedance port characteristic.

8. The antenna according to claim 1, wherein when the antenna operates, the antenna operates in a 0.5-time wavelength mode.

9. The antenna according to claim 1, wherein
when the antenna operates, a maximum current amplitude difference on the first radiator is less than a second value, the second value is a maximum current amplitude difference on a radiator when a dipole antenna operates, and a length of the radiator of the dipole antenna is the first value.

10. The antenna according to claim 1, wherein
the first radiator is in a stripe shape, and a straight line on which a long side of the first radiator is located is parallel to a reference ground.

11. The antenna according to claim 1, wherein the first radiator comprises a first part, a second part, and a third part that are connected in sequence; and
the first part is perpendicular to a reference ground, the third part is perpendicular to the reference ground, and the second part is disposed between the first part and the third part.

12. The antenna according to claim 1, wherein a ground stub is further comprised at a middle position of the first radiator.

13. The antenna according to claim 1, wherein
the first radiator is divided into at least two radiation units by at least one slot; two ends of each radiation unit are connected to the two signal output ends of the differential mode feed structure respectively; and
output ends of differential mode feed structures connected to a same side of any two radiation units have a same polarity.

14. The antenna according to claim 13, wherein a size of the slot is comprised in a range of [0.1 mm, 5 mm].

15. The antenna according to claim 1, wherein at least one capacitor is disposed in series to the first radiator; and
when a plurality of capacitors are connected in series to the first radiator, at least part of the first radiator is comprised between any two of the capacitors.

16.-17. (canceled)

18. An electronic device, wherein the antenna according to claim 1 is disposed in the electronic device; and when transmitting or receiving a signal, the electronic device transmits or receives the signal through the antenna.
